(19) United States
(12) Patent Application Publication
(10) Pub. No.: US 2018/0290659 A1
(43) Pub. Date: Oct. 11, 2018

(54) CONTROL APPARATUS FOR HYBRID VEHICLE AND CONTROL METHOD OF HYBRID VEHICLE

(71) Applicant: TOYOTA JIDOSHA KABUSHIKI KAISHA, Toyota-shi (JP)

(72) Inventors: Yuta Tsukada, Shizuoka-ken (JP); Yu Miyahara, Susono-shi (JP); Yusuke Kitazawa, Susono-shi (JP); Tetsuhiro Maki, Susono-shi (JP)

(73) Assignee: TOYOTA JIDOSHA KABUSHIKI KAISHA, Toyota-shi (JP)

(21) Appl. No.: 15/944,301

(22) Filed: Apr. 3, 2018

(30) Foreign Application Priority Data
Apr. 5, 2017 (JP) 2017-075491

(51) Int. Cl. B60W 30/20; B60W 20/40; B60W 10/06; B60W 10/08; B60W 20/15; B60W 50/00

(52) U.S. Cl. CPC B60W 30/20; B60W 20/40; B60W 10/06; B60W 10/08; B60W 20/15; B60W 50/00; Y10S 903/93; B60W 2050/0057; B60W 2050/0021; B60W 2510/082; B60W 2510/0638; B60W 2710/0644; B60W 2710/083; B60W 2050/0055

(57) ABSTRACT

A control apparatus for a hybrid vehicle includes: a first controller configured to perform first control of causing a rotation speed of an engine to approach a target rotation speed; and a second controller disposed separately from the first controller and configured to perform second control of reducing vibration due to fluctuation of the rotation speed of the engine by controlling a torque which is output from an electric motor connected to the engine. The second controller is configured to control the electric motor such that a torque associated with the second control is not output in a first frequency area which is a control frequency range of a transfer function of the first controller and to control the electric motor such that the torque associated with the second control is output in a second frequency area of a transfer function of the second controller which is higher than the first frequency area.

### INCORPORATION BY REFERENCE

The disclosure of Japanese Patent Application No. 2017-075491 filed on Apr. 5, 2017 including the specification, drawings and abstract is incorporated herein by reference in its entirety.

### BACKGROUND

### 1. Technical Field

The disclosure relates to a control apparatus for a hybrid vehicle and a control method of a hybrid vehicle that perform control of reducing an influence of fluctuation of a rotation speed of an internal combustion engine.

### 2. Description of Related Art

Japanese Unexamined Patent Application Publication No. 2010-274875 (JP 2010-274875 A) discloses a technique of reducing fluctuation of a rotation speed due to an explosion cycle of an internal combustion engine. In JP 2010-274875 A, a technique has been proposed where fluctuation of a rotation speed of the internal combustion engine is reduced using a torque which is output from an electric motor. In this technique, a target rotation speed is corrected based on fluctuation of a rotation speed due to a torque which is applied to the electric motor (that is, a torque for reducing fluctuation of a rotation speed of the internal combustion engine) and performing feedback control.

### SUMMARY

Rotation speeds of an internal combustion engine and an electric motor are controlled by, for example, an electronic control unit (ECU), but an ECU that controls the rotation speed of the internal combustion engine and an ECU that controls the rotation speed of the electric motor may be separately provided to avoid an increase in size of a single ECU. Alternatively, a control block that controls the rotation speed of the internal combustion engine and a control block that controls the rotation speed of the electric motor may be separately provided in the same hardware. In this case, since the ECUs or the control blocks are independent of each other, a deviation from a target rotation speed, a response delay, or the like may occur, and a torque of the internal combustion engine and a torque of the electric motor may conflict with each other (that is, the controls may interfere with each other), whereby appropriate control cannot be performed. Specifically, there is a likelihood that haunting of control, an excessive increase or decrease of the torque of the internal combustion engine, erroneous learning in learning control, or the like will occur.

The disclosure provides a control apparatus for a hybrid vehicle and a control method of a hybrid vehicle that can appropriately reduce an influence of fluctuation of a rotation speed of an internal combustion engine.

A first aspect of the disclosure provides a control apparatus for a hybrid vehicle. The hybrid vehicle includes an internal combustion engine and an electric motor. The controller includes a first controller and a second controller. The first controller is configured to perform a first control of causing a rotation speed of the internal combustion engine to approach a target rotation speed. The second controller is configured to perform a second control of reducing vibration due to fluctuation of the rotation speed of the internal combustion engine by controlling a torque which is output from the electric motor connected to the internal combustion engine. The second controller is configured to control the electric motor such that a torque associated with the second control is not output in a first frequency area, the first frequency area being a control frequency range of a transfer function of the first controller and to control the electric motor such that the torque associated with the second control is output in a second frequency area of a transfer function of the second controller which is higher than the first frequency area.

In the control apparatus for a hybrid vehicle according to the disclosure, the torque associated with the second control of reducing vibration due to the fluctuation of the rotation speed of the internal combustion engine is not output from the electric motor in the first frequency area which is the control frequency range of the first control of causing the rotation speed of the internal combustion engine to approach the target rotation speed. On the other hand, the torque associated with the second control is output from the electric motor in the second frequency area which is higher than the control frequency range of the first control. The “control frequency range” refers to a frequency range in which a transfer function in control (that is, a transfer function of a system that performs the control) has high sensitivity. Typically, the first control has a large transfer coefficient at a relatively low frequency (for example, DC to 1 Hz).

When an output of the torque associated with the second control is switched between the first frequency area and the second frequency area as described above, a control frequency of the first control and a control frequency of the second control do not overlap each other and it is thus possible to avoid interference between the first control and the second control. Accordingly, it is possible to avoid a problem which will occur due to interference between the first control and the second control and to appropriately reduce an influence of fluctuation of the rotation speed of the internal combustion engine.

In the control apparatus, the second frequency area may include a resonance frequency of a drive system including the internal combustion engine and the electric motor.

According to this aspect, since resonance of the drive system can be suppressed by the second control, it is possible to effectively reduce occurrence of vibration in the hybrid vehicle.

In the control apparatus, the second controller may be configured to acquire a rotation speed signal indicating fluctuation of a rotation speed of the electric motor over time. The second controller may be configured to perform a filter process of cutting off a component of the rotation speed signal corresponding to the first frequency area and passing a component corresponding to the second frequency area. The second controller may be configured to determine the torque associated with the second control based on the rotation speed signal subjected to the filter process.

According to this aspect, since the component corresponding to the first frequency area in the rotation speed signal indicating the fluctuation of the rotation speed of the electric motor over time is cut off, the torque associated with the second control corresponding to the first frequency area is not calculated and thus the torque associated with the second control is not output in the first frequency area. On the other hand, since the component corresponding to the second frequency area is passed, the torque associated with the second control is output in the second frequency area. As a result, it is possible to appropriately avoid interference between the first control and the second control.

In the control apparatus, the second controller may be configured to acquire a rotation speed signal indicating fluctuation of a rotation speed of the electric motor over time. The second controller may be configured to detect fluctuation of an angular acceleration by differentiating the rotation speed signal. The second controller may be configured to determine the torque associated with the second control based on the fluctuation of the angular acceleration.

According to this aspect, fluctuation of an angular acceleration corresponding to the second frequency area in which the frequency is relatively high is detected by differentiating the rotation speed signal. Since the frequency in the fluctuation of the angular acceleration of the electric motor is relatively high (specifically, high in the first frequency area), the torque associated with the second control corresponding to the first frequency area is not output by determining the torque associated with the second control based on the detected fluctuation of the angular acceleration, and thus the torque associated with the second control is not output in the first frequency area. On the other hand, the torque associated with the second control is output in the second frequency area corresponding to the angular acceleration of the electric motor. As a result, it is possible to appropriately avoid interference between the first control and the second control.

In the control apparatus, the second controller may be configured to calculate fluctuation of a torsion torque in one of an input shaft and a damper connected to the internal combustion engine from an amount of strain due to torsion of one of the input shaft and the damper. The second controller may be configured to determine the torque associated with the second control based on the fluctuation of the torsion torque.

According to this aspect, fluctuation of a torsion torque corresponding to the second frequency area in which the frequency is relatively high is detected. Since the frequency in the fluctuation of the torsion torque is relatively high (specifically, the first frequency area is higher), the torque associated with the second control corresponding to the first frequency area is not output by determining the torque associated with the second control based on the detected fluctuation of the torsion torque, and thus the torque associated with the second control is not output in the first frequency area. On the other hand, the torque associated with the second control is output in the second frequency area corresponding to the fluctuation of the torsion torque. As a result, it is possible to appropriately avoid interference between the first control and the second control.

A second aspect of the disclosure provides a control apparatus for a hybrid vehicle. The hybrid vehicle includes an internal combustion engine and an electric motor. The control apparatus includes at least one electronic control unit. The at least one electronic control unit is configured to perform first control of causing a rotation speed of the internal combustion engine to approach a target rotation speed. The at least one electronic control unit is configured to perform second control of reducing vibration due to fluctuation of a rotation speed of the internal combustion engine by controlling a torque which is output from the electric motor connected to the internal combustion engine. The at least one electronic control unit is configured to control the electric motor such that a torque associated with the second control is not output in a first frequency area which is a control frequency range of the first control. The at least one electronic control unit is configured to control the electric motor such that the torque associated with the second control is output in a second frequency area which is higher than the first frequency area.

A third aspect of the disclosure provides a control method of a hybrid vehicle. The hybrid vehicle includes an internal combustion engine, an electric motor, and at least one electronic control unit. The control method includes: performing, by the at least one electronic control unit, first control of causing a rotation speed of the internal combustion engine to approach a target rotation speed; performing, by the at least one electronic control unit, second control of reducing vibration due to fluctuation of a rotation speed of the internal combustion engine by controlling a torque which is output from the electric motor connected to the internal combustion engine; controlling, by the at least one electronic control unit, the electric motor such that a torque associated with the second control is not output in a first frequency area which is a control frequency range of the first control; and controlling, by the at least one electronic control unit, the electric motor such that the torque associated with the second control is output in a second frequency area which is higher than the first frequency area.

Operations and other advantages of the disclosure will become apparent from embodiments of the disclosure which will be described below.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram illustrating a configuration of a control apparatus for a hybrid vehicle according to a first embodiment;

FIG. 2 is a block diagram illustrating a configuration of a MG rotation speed control unit according to the first embodiment;

FIG. 3 is a Bode diagram illustrating an example of a transfer function of a system;

FIG. 4 is a map illustrating interference between engine rotation speed control and MG rotation speed control;

FIG. 5 is a timing chart illustrating an increase in a torque fluctuation due to interference between control;

FIG. 6 is a flowchart illustrating a flow of operations of the control apparatus for a hybrid vehicle according to the first embodiment;

FIG. 7 is a map illustrating filter characteristics of a filter processing unit;

FIG. 8 is a timing chart illustrating fluctuation of an engine rotation speed and a MG rotation speed subjected to the filter process;

FIG. 9 is a block diagram illustrating a configuration of a MG rotation speed control unit according to a second embodiment;

FIG. 10 is a flowchart illustrating a flow of operations of a control apparatus for a hybrid vehicle according to the second embodiment;

FIG. 11 is a timing chart illustrating fluctuation of an engine rotation speed and an angular acceleration;

FIG. 12 is a block diagram illustrating a configuration of a MG rotation speed control unit according to a third embodiment;

FIG. 13 is a flowchart illustrating a flow of operations of a control apparatus for a hybrid vehicle according to the third embodiment; and

FIG. 14 is a timing chart illustrating fluctuation of an engine rotation speed and a torsion torque.

### DETAILED DESCRIPTION OF EMBODIMENTS

Hereinafter, embodiments of the disclosure will be described with reference to the accompanying drawings.

### First Embodiment

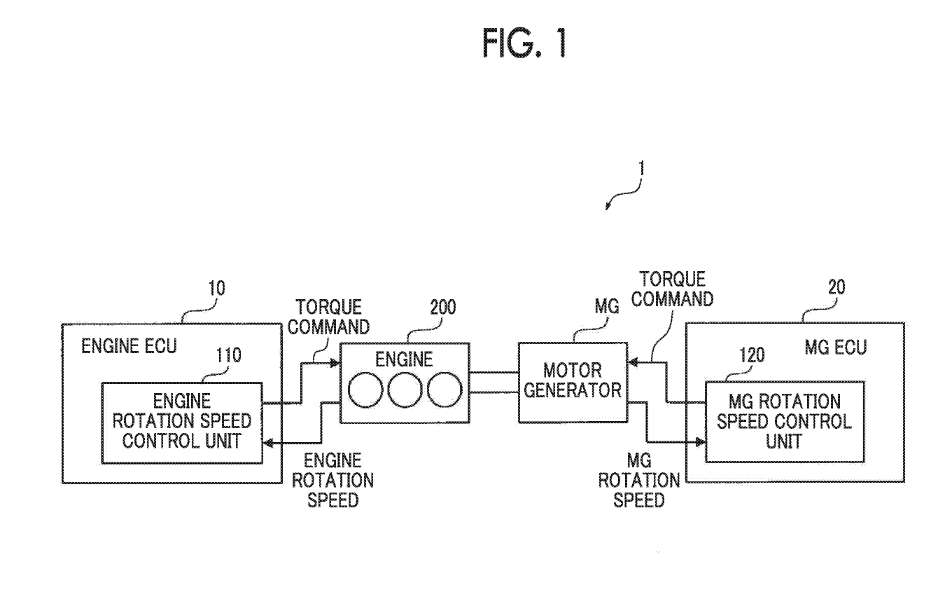

A control apparatus for a hybrid vehicle according to a first embodiment will be described below with reference to FIGS. 1 to 8.

Device configuration First, a configuration of a control apparatus for a hybrid vehicle according to this embodiment will be described with reference to FIG. 1. FIG. 1 is a block diagram illustrating a configuration of a control apparatus for a hybrid vehicle according to the first embodiment.

As illustrated in FIG. 1, a control apparatus for a hybrid vehicle according to this embodiment is configured to control operations of an engine 200 and a motor generator MG which are mounted in the hybrid vehicle. The engine 200 is an example of an “internal combustion engine.” The engine 200 according to this embodiment is a gasoline engine that serves as a main power source of the hybrid vehicle 1. The motor generator MG is an example of an “electric motor.” The motor generator MG is an electric motor generator having a powering function of converting electric energy into kinetic energy and a regeneration function of converting kinetic energy into electric energy. In FIG. 1, the engine 200 and the motor generator MG are illustrated as being connected directly to each other, but may be connected, for example, via a planetary gear mechanism as long as it is a configuration capable of transmitting a torque therebetween.

The control apparatus for a hybrid vehicle according to this embodiment includes an engine ECU 10 which is an electronic control unit that controls an operation of the engine 200 and a MGECU 20 which is an electronic control unit that controls an operation of the motor generator MG. In this embodiment, particularly, the engine ECU 10 and the MGECU 20 are configured as ECUs which are independent of each other. The engine ECU 10 and the MGECU 20 can be technically configured as a single ECU (that is, a common ECU), but the size thereof may increase, for example, when such a single ECU is enabled to perform processes with large computing loads. Accordingly, the control apparatus for a hybrid vehicle according to this embodiment separately includes the engine ECU 10 that controls the engine 200 and the MGECU 20 that controls the motor generator MG Alternatively, the engine ECU 10 and the MGECU 20 may be configured as separate control blocks in the same ECU. That is, first control and second control which will be described later may be implemented by a plurality of control blocks or control circuits in at least one ECU.

The engine ECU 10 performs engine rotation speed control (first control) of outputting a torque command for causing an engine rotation speed to approach a target engine rotation speed based on an acquired rotation speed of the engine 200 (the engine rotation speed). The first control is implemented by an engine rotation speed control unit 110 illustrated in FIG. 1. The engine rotation speed control unit 110 is an example in which the first control which is performed by a “first controller” is expressed as a control block. The engine rotation speed control unit 110 causes the engine rotation speed to approach the target engine rotation speed, for example, by electronic fuel injection (EFI) control. The MGECU 20 performs MG rotation speed control (second control) of outputting a torque command for causing a MG rotation speed to approach a target MG rotation speed based on an acquired rotation speed of the motor generator MG (a MG rotation speed). The second control is implemented by an MG rotation speed control unit 120 illustrated in FIG. 1. The MG rotation speed control unit 120 is an example in which the second control which is performed by a “second controller” is expressed as a control block. The MG rotation speed control unit 120 can cause the motor generator MG to output a torque (hereinafter appropriately referred to as a “vibration control torque”) for reducing an influence of fluctuation of the rotation speed of the engine 200 in addition to a torque as a power source of the hybrid vehicle. The vibration control torque is a torque with a phase opposite to a fluctuation component of the rotation speed of the engine 200, and has an effect of reducing vibration (for example, vibration corresponding to a resonance frequency of a drive system) of the hybrid vehicle due to the fluctuation of the rotation speed of the engine 200.

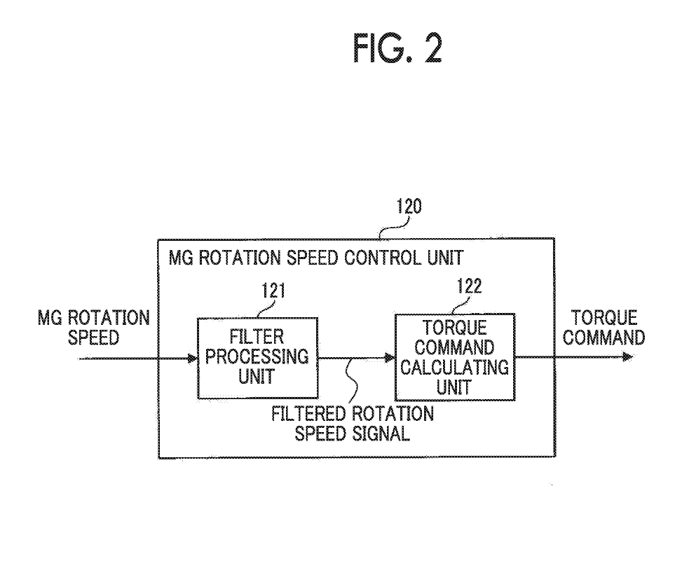

A configuration of the MG rotation speed control unit 120 will be specifically described below with reference to FIG. 2. FIG. 2 is a block diagram illustrating the configuration of the MG rotation speed control unit 120 according to the first embodiment.

As illustrated in FIG. 2, the MG rotation speed control unit 120 according to the first embodiment includes a filter processing unit 121 and a torque command calculating unit 122 as processing blocks implemented therein or hardware. The filter processing unit 121 acquires an MG rotation speed signal indicating fluctuation of the MG rotation speed over time and performs a predetermined filter process on the acquired MG rotation speed signal. The filter processing unit 121 is configured to output an MG rotation speed signal subjected to the filter process to the torque command calculating unit 122. The torque command calculating unit 122 outputs a torque command signal indicating a torque which should be output from the motor generator MG based on the MG rotation speed signal subjected to the filter process. More specific operation details of the filter processing unit 121 and the torque command calculating unit 122 will be described later.

Interference Between Rotation Speed Controls

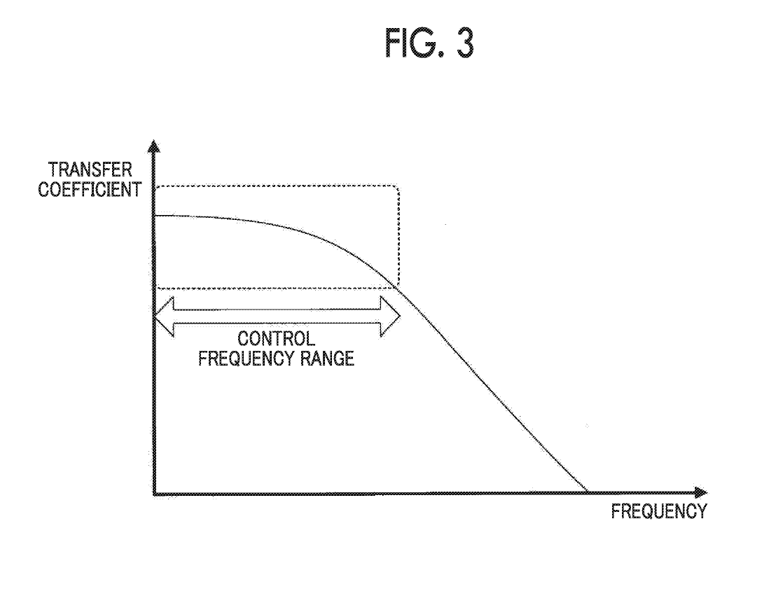

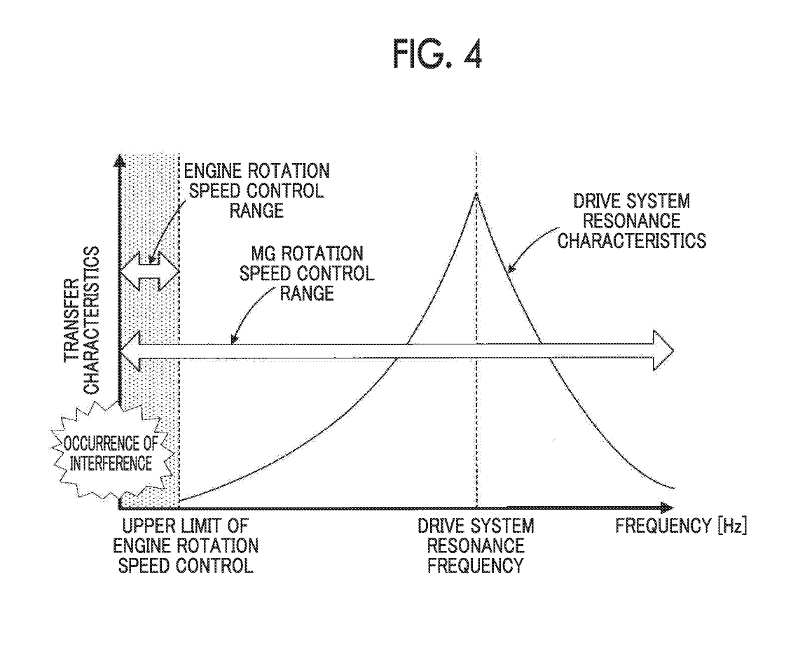

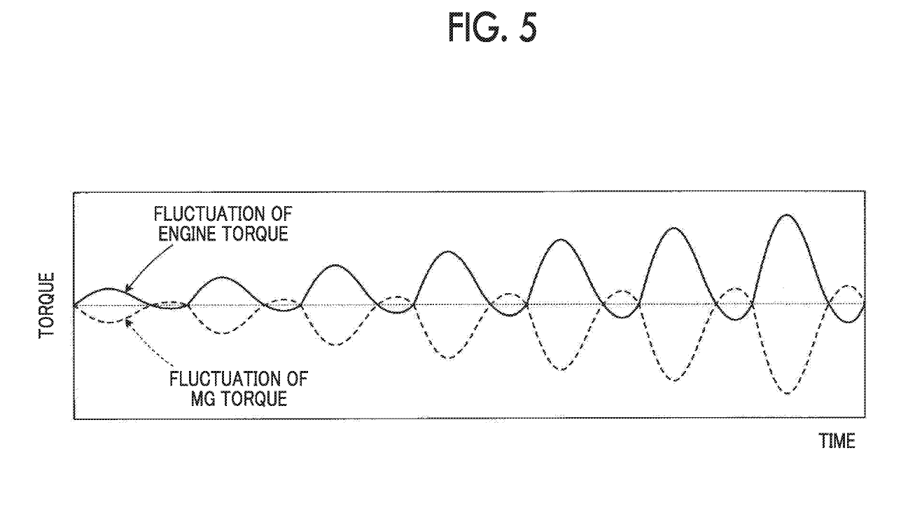

Interference between the engine rotation speed control which is performed by the engine rotation speed control unit 110 and the MG rotation speed control which is performed by the MG rotation speed control unit 120 will be described below with reference to FIGS. 3 to 5. FIG. 3 is a Bode diagram illustrating an example of a transfer function of a system. FIG. 4 is a map illustrating interference between the engine rotation speed control and the MG rotation speed control. FIG. 5 is a timing chart illustrating an increase in a torque fluctuation due to the interference between controls.

As illustrated in FIG. 3, the control frequency range of each control is defined as a high-sensitivity area of a transfer function (specifically, a transfer function which is determined depending on specifications of a mechanical part and a software part for performing the control) of a system that performs the control. That is, like a part surrounded with a dotted line in the drawing, a frequency range in which a transfer coefficient is high is defined as the control frequency range.

In a comparative example illustrated in FIG. 4, the control frequency range of the engine rotation speed control is a relatively low frequency area which is equal to or lower than 1 Hz, and the control frequency range of the MG rotation speed control is a frequency area which is higher than the control frequency range of the engine rotation speed control to reduce vibration due to the resonance frequency (for example, 8 Hz) of the drive system. At this time, there is a likelihood that interference between controls will occur in the area (see a hatched part in the drawing) in which the control frequency range of the engine rotation speed control and the control frequency range of the MG rotation speed control overlap each other.

Specifically, the engine ECU 10 and the MGECU 20 are configured as independent ECUs. Accordingly, when separation from a target rotation speed or a response delay of the engine 200 and the motor generator MG occurs, a torque (an engine torque) output from the engine 200 and a torque (an MG torque) output from the motor generator MG conflict with each other and there is concern that haunting of control, an excessive increase or decrease of the engine torque, erroneous learning in learning control, or the like will occur. Such a problem may also occur when the engine ECU 10 and the MGECU 20 are configured as separate control blocks in the same ECU.

In the example illustrated in FIG. 5, fluctuation widths of the engine torque and the MG torque increase with the lapse of time during a self-sustaining operation (that is, during an idling operation) of the engine 200. This is because a feedback process in the engine rotation speed control and the MG rotation speed control cannot be normally performed due to the interference between controls. Such an excessive increase of the engine torque has an adverse influence on the engine rotation speed control and the MG rotation speed control.

The control apparatus for a hybrid vehicle according to this embodiment performs the engine rotation speed control and the MG rotation speed control using a method which will be described below in detail to solve the above-mentioned problem.

Description of Operations

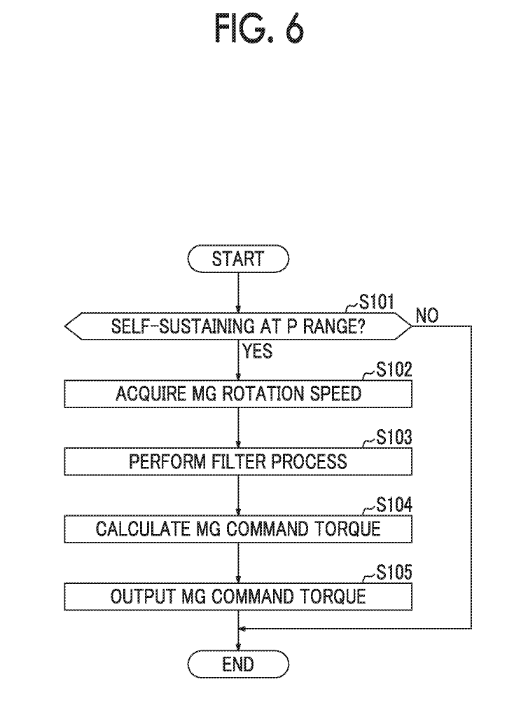

Operations (particularly, a vibration control torque output operation of the MG rotation speed control unit 120) of the control apparatus for a hybrid vehicle according to the first embodiment will be described below in detail with reference to FIG. 6. FIG. 6 is a flowchart illustrating a flow of operations of the control apparatus for a hybrid vehicle according to the first embodiment.

In FIG. 6, the vibration control torque output operation according to this embodiment is performed when the engine 200 performs a self-sustaining operation at a P range under the engine rotation speed control. Accordingly, when it is determined that the engine 200 does not perform a self-sustaining operation at the P range (NO in Step S101), subsequent processes thereof are not performed and the operation ends.

On the other hand, when it is determined that the engine 200 performs a self-sustaining operation at the P range (YES in Step S101), the filter processing unit 121 acquires an MG rotation speed signal indicating the MG rotation speed (Step S102). Subsequently, the filter processing unit 121 performs a predetermined filter process on the acquired MG rotation speed signal (Step S103). The MG rotation speed signal subjected to the filter process is output to the torque command calculating unit 122.

Thereafter, the torque command calculating unit 122 calculates an MG command torque based on the MG rotation speed signal subjected to the filter process (Step S104). That is, a torque for causing the MG rotation speed to approach the target MG rotation speed is calculated. The calculated torque includes a vibration control torque, and since existing techniques can be appropriately employed to calculate the vibration control torque, detailed description thereof will not be made herein. Subsequently, the torque command calculating unit 122 outputs the calculated MG command torque to the motor generator MG (Step S105). Accordingly, a torque including the vibration control torque is output from the motor generator MG.

The above-mentioned series of processes are started again from Step S101 after a predetermined time elapses. Accordingly, the processes of Step S102 to S105 are performed while the engine 200 performs a self-sustaining operation at the P range.

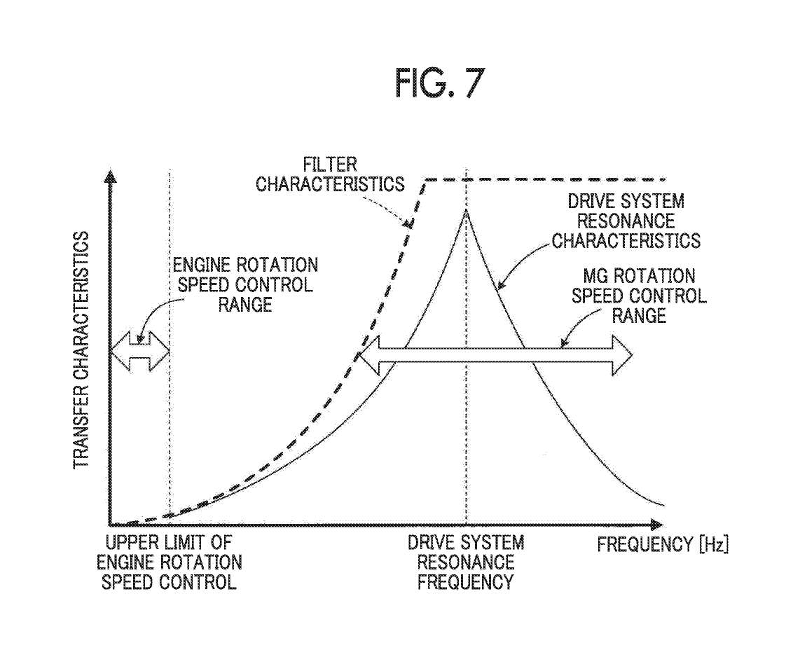

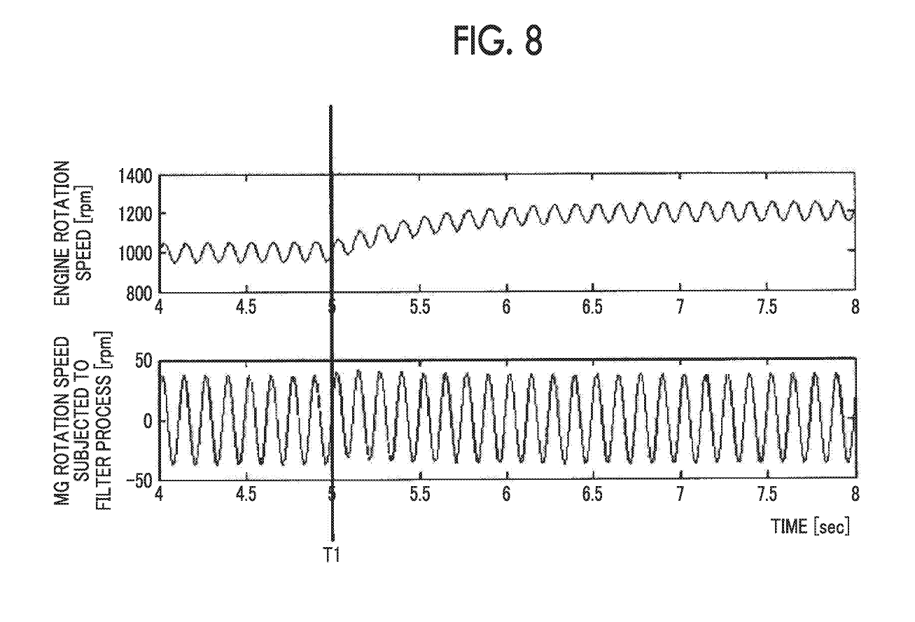

Advantages of embodiment Technical advantages obtained from the operations of the control apparatus for a hybrid vehicle according to the first embodiment will be described below in detail with reference to FIGS. 7 and 8. FIG. 7 is a map illustrating filter characteristics of the filter processing unit. FIG. 8 is a timing chart illustrating fluctuation of the engine rotation speed and the MG rotation speed subjected to the filter process.

As illustrated in FIG. 7, the filter processing unit 121 has filter characteristics where a gain is very small in an engine rotation speed control range (that is, which is the control frequency range of the engine rotation speed control and is a relatively low frequency area) and the gain increases depending on the drive system resonance characteristics. Accordingly, in the filter process by the filter processing unit 121, a component corresponding to the frequency area of the engine rotation speed control range is cut off and a component corresponding to a frequency area in the vicinity of the drive system resonance frequency is passed. As a result, when the MG command torque is calculated based on the MG rotation speed signal subjected to the filter process, the MG rotation speed control is performed in a frequency area does not include the frequency area of the engine rotation speed control range but does include the drive system resonance frequency. Accordingly, it is possible to prevent interference between the engine rotation speed control and the MG rotation speed control with each other and to appropriately reduce vibration of the hybrid vehicle.

In the example illustrated in FIG. 7, a frequency area in which neither the engine rotation speed control nor the MG rotation speed control is performed may be present or may not be present between the engine rotation speed control range and an MG rotation speed control range (i.e., a control frequency range of the MG rotation speed control). That is, when the MG rotation speed control range includes the drive system resonance frequency while avoiding overlap of the engine rotation speed control range and the MG rotation speed control range, the above-mentioned technical advantages can be surely obtained.

In the example illustrated in FIG. 8, a target engine rotation speed in the engine rotation speed control is changed from 1000 rpm to 1200 rpm at time T1. At this time, the MG rotation speed signal subjected to the filter process is hardly changed before and after time T1. This means that only a fluctuation component of the rotation speed of the motor generator MG in an area separated in frequency from the fluctuation of the engine rotation speed (that is, fluctuation at a relatively low frequency) by the engine rotation speed control can be extracted by performing a high-pass filter process as illustrated in FIG. 7. More specifically, the component of the engine rotation speed control range of relatively low frequencies is cut off and only the fluctuation component of relatively high frequencies is extracted. Accordingly, when the MG command torque is calculated based on the MG rotation speed signal subjected to the filter process, it is possible to perform the MG rotation speed control without affecting the engine rotation speed control (for example, control accompanying fluctuation of the engine rotation speed in an area of relatively low frequencies to correspond to a change of the target engine rotation speed). Accordingly, it is possible to prevent interference between the engine rotation speed control and the MG rotation speed control with each other and to appropriately reduce vibration of the hybrid vehicle.

### Second Embodiment

A control apparatus for a hybrid vehicle according to a second embodiment will be described below. The second embodiment is different from the first embodiment in only some configurations and operations, and both embodiments are equal to each other in the other parts. Accordingly, differences from the above-mentioned first embodiment will be described below in detail and the same parts will not be appropriately repeated.

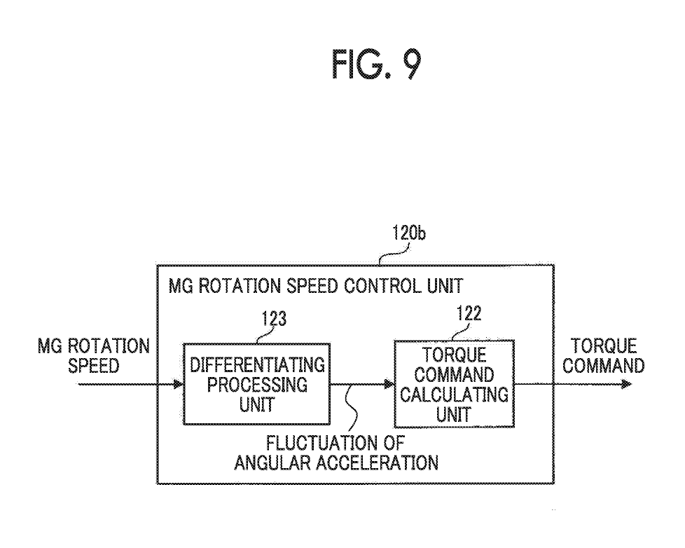

Device configuration A configuration of an MG rotation speed control unit according to the second embodiment will be described below with reference to FIG. 9. FIG. 9 is a block diagram illustrating the configuration of the MG rotation speed control unit according to the second embodiment.

As illustrated in FIG. 9, the MG rotation speed control unit 120b according to the second embodiment includes a differentiation process unit 123 and a torque command calculating unit 122 as processing blocks implemented therein or hardware. The differentiation process unit 123 acquires an MG rotation speed signal indicating fluctuation of the MG rotation speed over time and performs a differentiating process on the acquired MG rotation speed signal. The MG rotation speed signal becomes a signal indicating an angular acceleration of the motor generator MG by the differentiating process. The differentiation process unit 123 is configured to output the signal indicating the angular acceleration to the torque command calculating unit 122. The torque command calculating unit 122 outputs a torque command signal indicating a torque which should be output from the motor generator MG based on the signal indicating the angular acceleration.

Description of Operations

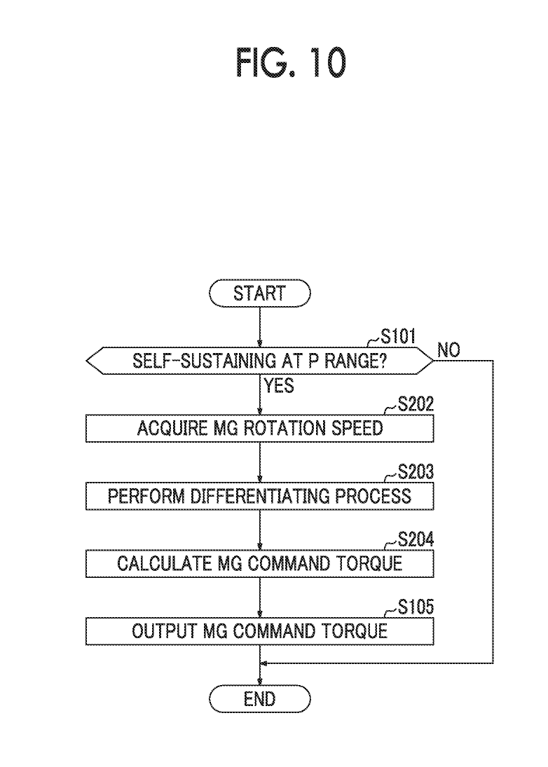

Operations (particularly, an operation of outputting a vibration control torque which is performed by the MG rotation speed control unit 120b) of the control apparatus for a hybrid vehicle according to the second embodiment will be described below in detail with reference to FIG. 10. FIG. 10 is a flowchart illustrating a flow of operations of the control apparatus for a hybrid vehicle according to the second embodiment.

In FIG. 10, when the control apparatus for a hybrid vehicle according to the second embodiment operates and it is determined that the engine 200 performs a self-sustaining operation at the P range (YES in Step S101), the differentiation process unit 123 acquires the MG rotation speed signal indicating the MG rotation speed (Step S202), and performs a differentiating process on the acquired MG rotation speed signal (Step S203). The signal, which has been acquired by the differentiating process, indicating the angular acceleration is output to the torque command calculating unit 122.

Thereafter, the torque command calculating unit 122 calculates an MG command torque including a vibration control torque based on the signal indicating the angular acceleration (Step S204). That is, a torque for causing the MG rotation speed to approach a target MG rotation speed is calculated. Subsequently, the torque command calculating unit 122 outputs the calculated MG command torque to the motor generator MG (Step S105). Accordingly, a torque including the vibration control torque is output from the motor generator MG.

### Advantages of Embodiment

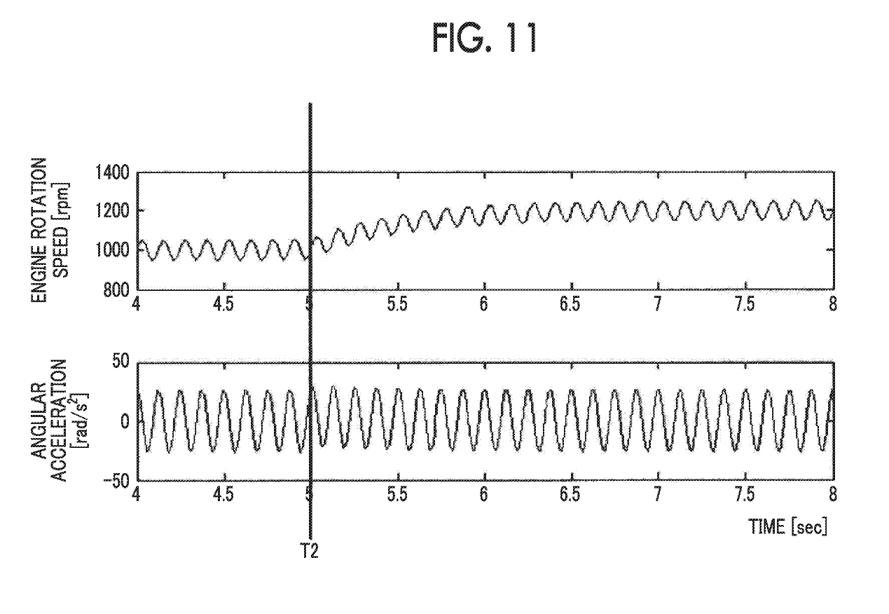

Technical advantages obtained from the operations of the control apparatus for a hybrid vehicle according to the second embodiment will be described below in detail with reference to FIG. 11. FIG. 11 is a timing chart illustrating fluctuation of the engine rotation speed and the angular acceleration.

In the example illustrated in FIG. 11, a target engine rotation speed in the engine rotation speed control is changed from 1000 rpm to 1200 rpm at time T2. At this time, the signal, which has been subjected to the differentiating process, indicating the angular acceleration is hardly changed before and after time T2. This means that only a fluctuation component of the rotation speed of the motor generator MG in an area separated in frequency from the fluctuation of the engine rotation speed (that is, fluctuation at a relatively low frequency) by the engine rotation speed control can be extracted by performing the differentiating process. That is, almost the same advantage as the filter process in the first embodiment can be obtained by the differentiating process. Specifically, the component of the engine rotation speed control range of relatively low frequencies is cut off and only the fluctuation component of relatively high frequencies can be extracted. Accordingly, when the MG command torque is calculated based on the signal indicating the angular acceleration which is acquired by the differentiating process, it is possible to perform the MG rotation speed control without affecting the engine rotation speed control (for example, control accompanying fluctuation of the engine rotation speed in an area of relatively low frequencies to correspond to a change of the target engine rotation speed). Accordingly, it is possible to prevent interference between the engine rotation speed control and the MG rotation speed control with each other and to appropriately reduce vibration of the hybrid vehicle.

### Third Embodiment

A control apparatus for a hybrid vehicle according to a third embodiment will be described below. The third embodiment is different from the first and second embodiments in only some configurations and operations, and these embodiments are equal to each other in the other parts. Accordingly, differences from the above-mentioned first and second embodiments will be described below in detail and the same parts will not be appropriately repeated.

Device Configuration

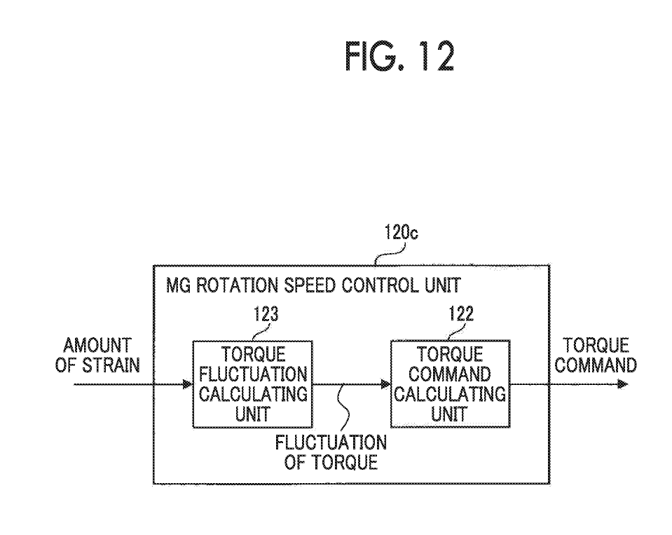

A configuration of an MG rotation speed control unit according to the third embodiment will be described below with reference to FIG. 12. FIG. 12 is a block diagram illustrating the configuration of the MG rotation speed control unit according to the third embodiment.

As illustrated in FIG. 12, the MG rotation speed control unit 120c according to the third embodiment includes a torque fluctuation calculating unit 124 and a torque command calculating unit 122 as processing blocks implemented therein or hardware. The torque fluctuation calculating unit 124 calculates fluctuation of a torque (that is, fluctuation of a torsion torque) corresponding to an amount of strain due to torsion of an input shaft or a damper (neither of which is illustrated) connected to the engine 200. The torque fluctuation calculating unit 124 is configured to output a signal indicating the calculated fluctuation of the torsion torque (hereinafter appropriately referred to as a “torque fluctuation”) to the torque command calculating unit 122. The torque command calculating unit 122 outputs a torque command signal indicating a torque which should be output from the motor generator MG based on the torque fluctuation corresponding to the amount of strain.

Description of Operations

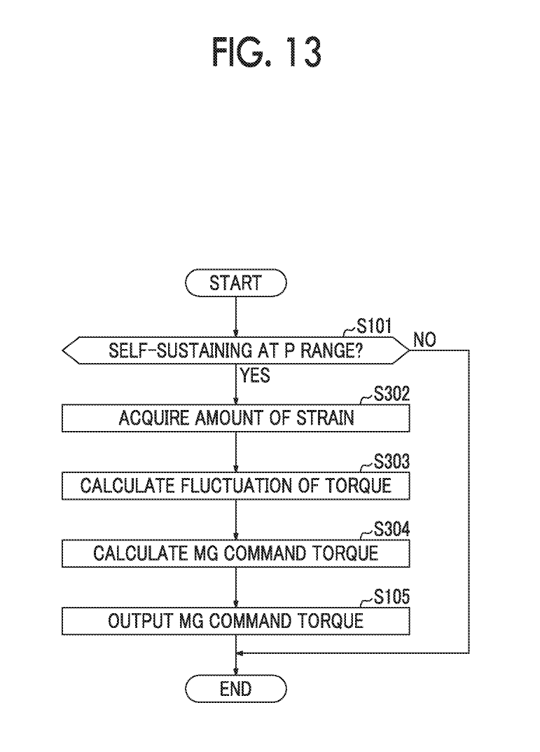

Operations (particularly, an operation of outputting a vibration control torque which is performed by the MG rotation speed control unit 120c) of the control apparatus for a hybrid vehicle according to the third embodiment will be described below in detail with reference to FIG. 13. FIG. 13 is a flowchart illustrating a flow of operations of the control apparatus for a hybrid vehicle according to the third embodiment.

In FIG. 13, when the control apparatus for a hybrid vehicle according to the third embodiment operates and it is determined that the engine 200 performs a self-sustaining operation at the P range (YES in Step S101), the torque fluctuation calculating unit 124 acquires the amount of strain of the input shaft or the damper (Step S302), and calculates a torque fluctuation corresponding to the acquired amount of strain (Step S303). The signal indicating the calculated torque fluctuation is output to the torque command calculating unit 122.

Thereafter, the torque command calculating unit 122 calculates an MG command torque including a vibration control torque based on the signal indicating the torque fluctuation (Step S304). That is, a torque for causing the MG rotation speed to approach a target MG rotation speed is calculated. Subsequently, the torque command calculating unit 122 outputs the calculated MG command torque to the motor generator MG (Step S105). Accordingly, a torque including the vibration control torque is output from the motor generator MG.

### Advantages of Embodiment

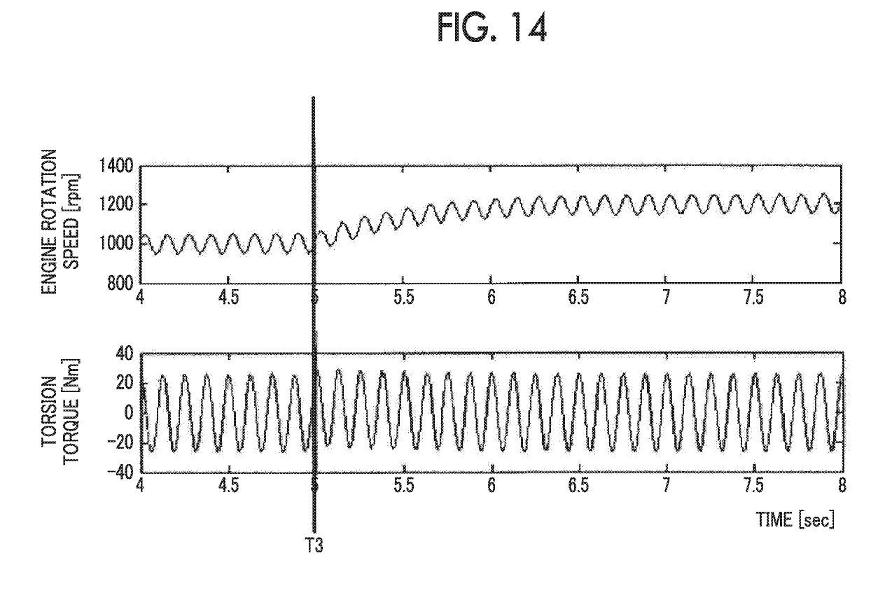

Technical advantages obtained from the operations of the control apparatus for a hybrid vehicle according to the third embodiment will be described below in detail with reference to FIG. 14. FIG. 14 is a timing chart illustrating fluctuation of the engine rotation speed and the torsion torque.

In the example illustrated in FIG. 14, a target engine rotation speed in the engine rotation speed control is changed from 1000 rpm to 1200 rpm at time T3. At this time, the signal indicating the torque fluctuation corresponding to the amount of strain is hardly changed before and after time T3. This means that only a fluctuation component of the rotation speed of the motor generator MG in an area separated in frequency from the fluctuation of the engine rotation speed (that is, fluctuation at a relatively low frequency) by the engine rotation speed control can be extracted by calculating the torque fluctuation corresponding to the amount of strain. That is, almost the same advantage as the filter process in the first embodiment and the differentiating process in the second embodiment can be obtained by calculating the torque fluctuation corresponding to the torsion torque. Specifically, the component of the engine rotation speed control range of relatively low frequencies is cut off and only the fluctuation component of relatively high frequencies can be extracted. Accordingly, when the MG command torque is calculated based on the fluctuation of the torsion torque, it is possible to perform the MG rotation speed control without affecting the engine rotation speed control (for example, control accompanying fluctuation of the engine rotation speed in an area of relatively low frequencies to correspond to a change of the target engine rotation speed). Accordingly, it is possible to prevent interference between the engine rotation speed control and the MG rotation speed control with each other and to appropriately reduce vibration of the hybrid vehicle.

The disclosure is not limited to the above-mentioned embodiments, but can be appropriately modified without departing from the gist or spirit of the disclosure which can be read from the appended claims and the whole specification. A control apparatus for a hybrid vehicle with such modifications is also included in the technical scope of the disclosure.

What is claimed is:

1. A control apparatus for a hybrid vehicle including an internal combustion engine and an electric motor, the control apparatus comprising:
a first controller configured to perform a first control of causing a rotation speed of the internal combustion engine to approach a target rotation speed; and
a second controller configured to perform a second control of reducing vibration due to fluctuation of the rotation speed of the internal combustion engine by controlling a torque which is output from the electric motor connected to the internal combustion engine,
the second controller being configured to control the electric motor such that a torque associated with the second control is not output in a first frequency area, said first frequency area being a control frequency range of a transfer function of the first controller, and said second controller is to control the electric motor such that the torque associated with the second control is output in a second frequency area of a transfer function of the second controller which is higher than the first frequency area.

2. The control apparatus for a hybrid vehicle according to claim 1, wherein the second frequency area includes a resonance frequency of a drive system including the internal combustion engine and the electric motor.

3. The control apparatus for a hybrid vehicle according to claim 1, wherein
the second controller is configured to acquire a rotation speed signal indicating fluctuation of a rotation speed of the electric motor over time,
the second controller is configured to perform a filter process of cutting off a component of the rotation speed signal corresponding to the first frequency area and passing a component corresponding to the second frequency area, and
the second controller is configured to determine the torque associated with the second control based on the rotation speed signal subjected to the filter process.

4. The control apparatus for a hybrid vehicle according to claim 1, wherein
the second controller is configured to acquire a rotation speed signal indicating fluctuation of a rotation speed of the electric motor over time,
the second controller is configured to detect fluctuation of an angular acceleration by differentiating the rotation speed signal, and
the second controller is configured to determine the torque associated with the second control based on the fluctuation of the angular acceleration.

5. The control apparatus for a hybrid vehicle according to claim 1, wherein
the second controller is configured to calculate fluctuation of a torsion torque in one of an input shaft and a damper connected to the internal combustion engine from an amount of strain due to torsion of one of the input shaft and the damper, and
the second controller is configured to determine the torque associated with the second control based on the fluctuation of the torsion torque.

6. A control apparatus for a hybrid vehicle including an internal combustion engine and an electric motor, the control apparatus comprising
at least one electronic control unit configured to perform a first control of causing a rotation speed of the internal combustion engine to approach a target rotation speed,
the at least one electronic control unit being configured to perform a second control of reducing vibration due to fluctuation of the rotation speed of the internal combustion engine by controlling a torque which is output from the electric motor connected to the internal combustion engine,
the at least one electronic control unit being configured to control the electric motor such that a torque associated with the second control is not output in a first frequency area, said first frequency area being a control frequency range of a transfer function of the first control of the at least one electronic control unit, and
the at least one electronic control unit being configured to control the electric motor such that the torque associated with the second control is output in a second frequency area of a transfer function of the second control of the at least one electronic control unit which is higher than the first frequency area.

7. A control method of a hybrid vehicle including an internal combustion engine, an electric motor, and at least one electronic control unit, the control method comprising:
performing, by the at least one electronic control unit, a first control of causing a rotation speed of the internal combustion engine to approach a target rotation speed;
performing, by the at least one electronic control unit, a second control of reducing vibration due to fluctuation of a rotation speed of the internal combustion engine by controlling a torque which is output from the electric motor connected to the internal combustion engine;
controlling, by the at least one electronic control unit, the electric motor such that a torque associated with the second control is not output in a first frequency area, said first frequency area being a control frequency range of a transfer function of the first control of the at least one electronic control unit; and
controlling, by the at least one electronic control unit, the electric motor such that the torque associated with the second control is output in a second frequency area of a transfer function of the second control of the at least one electronic control unit which is higher than the first frequency area.

8. The control method for a hybrid vehicle according to claim 7, wherein the second frequency area includes a resonance frequency of a drive system including the internal combustion engine and the electric motor.

9. The control apparatus for a hybrid vehicle according to claim 7, further comprising:
acquiring a rotation speed signal by the at least one electronic control unit indicating fluctuation of a rotation speed of the electric motor over time,
performing a filter process of cutting off a component of the rotation speed signal corresponding to the first frequency area and passing a component corresponding to the second frequency area, and
determining the torque associated with the second control based on the rotation speed signal subjected to the filter process.

10. The control method for a hybrid vehicle according to claim 7, further comprising:
acquiring a rotation speed signal by the at least one electronic control unit indicating fluctuation of a rotation speed of the electric motor over time,
detecting fluctuation of an angular acceleration by differentiating the rotation speed signal, and
determining the torque associated with the second control based on the fluctuation of the angular acceleration.

11. The control method for a hybrid vehicle according to claim 7, further comprising:
calculating fluctuation of a torsion torque in one of an input shaft and a damper connected to the internal combustion engine from an amount of strain due to torsion of one of the input shaft and the damper by the at least one electronic control unit, and
determining the torque associated with the second control based on the fluctuation of the torsion torque.
